(19) United States
(12) Patent Application Publication
(10) Pub. No.: US 2014/0215168 A1
(43) Pub. Date: Jul. 31, 2014

(54) SEMICONDUCTOR MEMORY DEVICE

(71) Applicant: KABUSHIKI KAISHA TOSHIBA, Tokyo (JP)

(72) Inventor: Takanobu OKUNO, Kanagawa (JP)

(73) Assignee: KABUSHIKI KAISHA TOSHIBA, Tokyo (JP)

(21) Appl. No.: 14/166,547

(22) Filed: Jan. 28, 2014

(30) Foreign Application Priority Data
Jan. 31, 2013 (JP) 2013-017901

(51) Int. Cl. G06F 3/06

(52) U.S. Cl. CPC G06F 3/0659; G06F 3/0604; G06F 3/0679
USPC 711/156

(57) ABSTRACT

A semiconductor memory device includes a first semiconductor chip which includes a first data input-output circuit connected to a plurality of output lines including first and second output lines and configured to output a status signal onto the first output line, and a second semiconductor chip which includes a second data input-output circuit connected to the plurality of output lines including the first and second output lines and configured to output a status signal onto the second output line.

### CROSS-REFERENCE TO RELATED APPLICATION

This application is based upon and claims the benefit of priority from Japanese Patent Application No. 2013-017901, filed Jan. 31, 2013, the entire contents of which are incorporated herein by reference.

### FIELD

Embodiments described herein relate generally to a semiconductor memory device.

### BACKGROUND

There has been an increase in the use of semiconductor memory devices which use memory such as NAND flash memory that stores a large volume of data such as images and videos that are consumed by mobile devices and the like, and a sharp increase in the demand for semiconductor memory devices. Fast operation and low power consumption are desired in these applications.

### DESCRIPTION OF THE DRAWINGS

FIG. 1 is a view showing an example of the connections between semiconductor chips and a memory controller within a semiconductor memory device of a first embodiment.

FIG. 2 is a block diagram illustrating the semiconductor memory device of the first embodiment.

FIG. 3 is a timing diagram of an operation command input and a status command input of the semiconductor memory device of the first embodiment.

FIG. 4 is a view showing an example of the connections between semiconductor chips and a memory controller within a semiconductor memory device of a second embodiment.

FIG. 5 is a block diagram illustrating the semiconductor memory device of the second embodiment.

FIG. 6 is a timing diagram of an operation command input and a status command input of the semiconductor memory device of the second embodiment.

FIG. 7 is a diagram showing a flow of operations of the semiconductor chips and the memory controller of the semiconductor memory device of the second embodiment.

### DETAILED DESCRIPTION

An embodiment provides a semiconductor memory device capable of reducing power consumption.

In general, according to one embodiment, a semiconductor memory device includes a first semiconductor chip which includes a first data input-output circuit connected to a plurality of output lines including first and second output lines and configured to output a status signal onto the first output line, and a second semiconductor chip which includes a second data input-output circuit connected to the plurality of output lines including the first and second output lines and configured to output a status signal onto the second output line.

The memory controller transmits a chip selection signal via first and second wirings to the first and second semiconductor chips, respectively, to select the first and second semiconductor chips at the same time, and transmits a status read command via a third wiring that includes a plurality of lines. In response, the first and second semiconductor chips transfer status data to the memory controller at the same time by outputting the status data to different lines of the third wiring.

### First Embodiment

Hereinafter, a semiconductor memory device of the embodiment will be described with reference to the drawings. For the description, the same components are given the same reference numerals across all of the drawings.

Configuration of Semiconductor Memory Device of First Embodiment

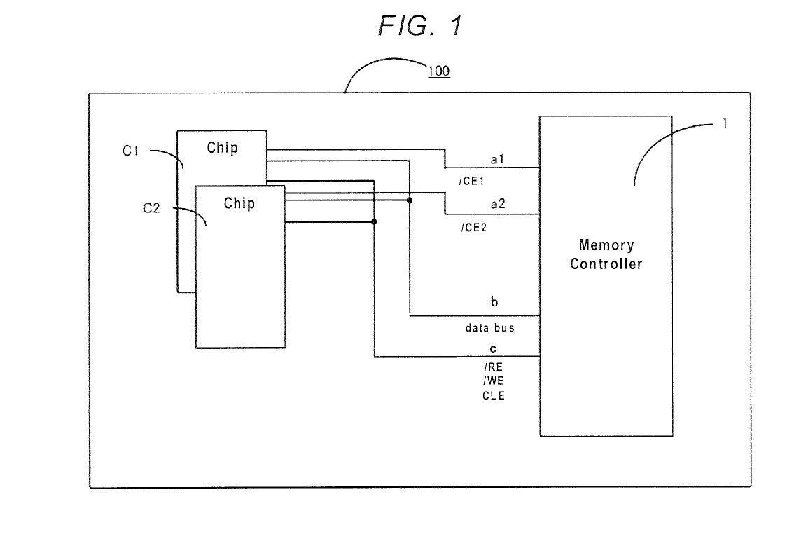

First, description will be given of the configuration of the semiconductor memory device of the first embodiment using FIG. 1. To simplify the description, an example is given in which the semiconductor memory device of the embodiment includes two semiconductor chips. The configuration is not limited thereto, however, and the number of semiconductor chips contained in the semiconductor memory device may be any number that is 2 or more.

1. Overall Configuration of Semiconductor Memory Device

As shown in FIG. 1, a semiconductor memory device 100 includes a plurality of semiconductor chips C1 and C2, and a memory controller 1. The detailed configuration of the semiconductor chips C1 and C2 will be given later. The memory controller 1 has a function of controlling the operations of the plurality of semiconductor chips C1 and C2.

In order to control the operations of the plurality of semiconductor chips C1 and C2, the memory controller 1 supplies, for example, a chip enable signal /CE1 or /CE2, a write enable signal /WE, a read enable signal /RE, a command latch enable signal CLE and the like to the semiconductor chips C1 and C2 via a plurality of signal lines a1, a2 and signal line group c. In addition, the memory controller 1 transmits status information to the semiconductor chips C1 and C2 via a commonly connected bus b.

As shown in FIG. 1, the signal lines a1 and a2 electrically connect the memory controller 1 to the semiconductor chips C1 and C2, respectively.

The memory controller 1 is commonly connected to each of the semiconductor chips C1 and C2 via the data bus b. In the same manner, the memory controller 1 is commonly connected to each of the semiconductor chips C1 and C2 via the signal line group c.

The memory controller 1 supplies the chip enable signals /CE1 and /CE2, which select each of the semiconductor chips C1 and C2, to each of the semiconductor chips C1 and C2 via the signal lines a1 and a2. For example, when the memory controller 1 selects only the semiconductor chip C1, the chip enable signal /CE1 is set to an “L” level, and the other chip enable signal /CE2 is set to an “H” level. Furthermore, in relation to the signal lines a1 and a2, when the number of semiconductor chips increases, the number of the signal lines is increased accordingly.

The memory controller 1 supplies data such as a command or an address to each of the semiconductor chips C1 and C2 via the data bus b (the input-output line). Meanwhile, each of the semiconductor chips C1 and C2 supplies the data of each of the semiconductor chips C1 and C2 to the memory controller 1 via the data bus b. For example, when the memory controller 1 is to read out data from the semiconductor chip C1, the chip enable signal /CE1 is set to the “L” level, and the other chip enable signal /CE2 is set to the “H” level. Accordingly, the output of the semiconductor chip C2 enters a high impedance state, and only the data of the semiconductor chip C1 is output to the bus b. Accordingly, data collisions can be prevented at the bus b, to which a plurality of semiconductor chips are connected.

The memory controller 1 supplies the signals of the write enable signal /WE, the read enable signal /RE, and the command latch enable signal CLE via the signal line group c.

2. Configuration of Semiconductor Chips

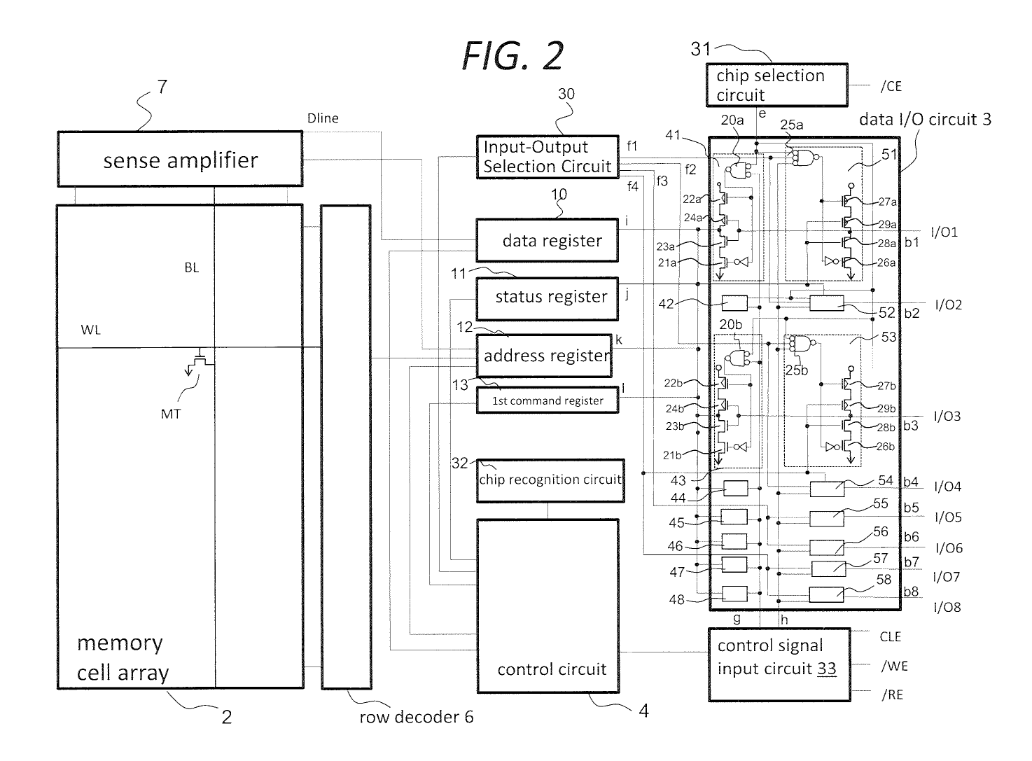

Next, description will be given of the configuration of the semiconductor chips C1 and C2 of the embodiment using FIG. 2.

To simplify the description, in FIG. 2, description is given using the semiconductor chip C1 as an example. Since the semiconductor chips C1 and C2 are configured in the same manner, detailed description of the semiconductor chip C2 will be omitted.

As shown in FIG. 2, the semiconductor chip C1 includes a memory cell array 2, a data input-output circuit 3, a control unit 4, a chip selection circuit 31, a chip recognition circuit 32 and a control signal input circuit 33.

A plurality of memory cells MT are present in the memory cell array 2. The memory cells MT are selected by a word line WL, which is selected by a row decoder 14. Data is output from the selected memory cells MT to a bit line BL, amplified by a sense amplifier 7 and output through a data line Dline of an inner portion of the chip to the input-output line via the data input-output circuit 3.

2-1. Regarding Data Input-Output Circuit

The data input-output circuit 3 includes first to eighth data input control units 41 to 48, which correspond to a first to eighth input-output units, respectively. The first to eighth data input control units 41 to 48 control the inputs to the first to eighth input-output units, respectively. For example, the first data input control unit 41 includes a first AND circuit 20 and first to fourth transistors 21a to 24a which are connected in series. The first AND circuit 20 receives the signals of the chip selection circuit 31 and the control signal input circuit 33 and outputs the signals to the first and second transistors 21a and 22a. The first transistor 21a includes an N-type channel MOS which is connected to an inverter, the second transistor 22a includes a P-type channel MOS, the third transistor 23a includes an N-type channel MOS and the fourth transistor 24a includes a P-type channel MOS. One end of the first transistor 21a is connected to ground, and the other end is connected to the third transistor 23a. One end of the second transistor 22a is connected to a VDD power supply, and the other end is connected to the fourth transistor 24a. One end of the third transistor 23a is connected to the first transistor 21a, and the other end is connected to the fourth transistor 24a. The configuration of second to eighth data input control units 42 to 48 is the same as that of the first data input control unit 41, and the first to fourth transistors 21a to 24a will be referred to as first to fourth transistors 21 to 24 when they are described in the context of any one of the data output control units 41 to 48 and not any one in particular. Furthermore, the present example describes an inverter-type input circuit, but the embodiments are not limited to this structure.

The data input-output circuit 3 includes first to eighth data output control units 51 to 58, which correspond to the first to eighth input-output units, respectively. The first to eighth data output control units 51 to 58 control the outputs of the first to eighth input-output units, respectively. For example, the first data output control unit 51 includes a second AND circuit 25 and fifth to eighth transistors 26a to 29a. The second AND circuit 25 receives the signals of the input-output selection circuit 30, the chip selection circuit 31 and the control signal input circuit 33 and outputs the signals to the fifth and the sixth transistors 26a and 27a. The second to eighth data output control units 52 to 58 have the same structures as the first data output control unit 51, and the fifth to eighth transistors 26a to 29a will be referred to as fifth to eighth transistors 26 to 29 when they are described in the context of any one of the data output control units 51 to 58 and not any one in particular.

When outputting the data which is readout from the memory cell array 2 to the host, on the basis of the control of the control unit 4, the data input-output circuit 3 receives the data which is amplified by the sense amplifier 7 via a data register 10 and subsequently outputs the data to the host via the input-output line.

The data input-output circuit 3 has an input state, an output state and a high impedance state, and when the chip is not selected using a selection signal, the data input-output circuit 3 enters the high impedance state. During the data output of the memory cell MT, for example, when there are 8 input-output lines (shown in FIG. 2 as I/O 1 through I/O 8), all 8 lines enter the output state.

The data input-output circuit 3 receives data, which indicates that the semiconductor chip C1 is selected, from the control unit 4. In addition, for example, data is output to the two data that are selected (e.g., I/O 1 and I/O 2) from among the 8 data buses on the basis of a chip recognition circuit 32 and an input-output selection circuit 30. Accordingly, when the status data is supplied from the semiconductor chip C1 to the memory controller 1, the status data is transferred using the two data buses I/O 1 and I/O 2. The remaining 6 data buses I/O 3 to I/O 8 of the semiconductor chip C1 enter the high impedance state. In the same manner, the data input-output circuit 3 of the semiconductor chip C2 transfers the status data using the two data buses that are different from the semiconductor chip C1 (e.g., I/O 3 and I/O 4), on the basis of the input-output selection circuit 30. The remaining 6 data buses I/O 1, I/O 2, and I/O 5 to I/O 8 of the semiconductor chip C2 enter the high impedance state.

As described above, when transferring the status data of the semiconductor chips C1 and C2, the common bus b is used. However, since data buses which correspond respectively to the semiconductor chips C1 and C2 are selectively used, data collisions do not occur on the common bus and data readout errors do not occur.

2-2. Regarding Input-Output Selection Circuit

When the input-output selection circuit 30 outputs data, the input-output selection circuit 30 selects the input-output of the output bus d on the basis of the information of the chip recognition circuit 32.

2-3. Regarding Control Circuit (Control Unit)

The control unit 4 controls the operations of the NAND flash memory. In other words, an operation sequence of a writing operation, a reading operation and an erasing operation of the data is executed on the basis of the address and the command which are provided from the host via the data input-output circuit 3.

The control unit 4 has a function of setting the status data in a status register 11 described later. When the control unit 4 performs the writing operation, the reading operation or the erasing operation of the data, the control unit 4 sets the status data in the status register 11. For example, when the writing operation is finished, the status is set to “Ready”, and during the writing operation, the status is set to “Busy”.

2-4. Chip Recognition Circuit

The chip recognition circuit 32 functions in order to distinguish itself from the other chips, of the plurality of semiconductor chips.

2-5. Status Register

The status register 11 has a function of maintaining the status data which indicates the status of the semiconductor chips C1 and C2. The status register 11 is electrically connected to the control unit 4.

According to the control unit 4, the status register 11 supplies the status data, which is set therein, to the data input-output circuit 3. The status register 11 outputs the status data to the memory controller 1 via the data input-output circuit 3.

2-6. Data Register

The data register 10 is electrically connected to the control unit 4. The data register 10 transmits and receives data between itself and the sense amplifier 7 via the data line Dline.

2-7. Address Register

An address register 12 maintains the address information, and the information of the blocks, pages and planes of the memory cell array. In addition, the address register 12 propagates the address information, which is supplied from an external host, to the control unit 4.

2-8. First Command Register

A first command register 13 stores a command, which is received from the data input-output circuit 3, and transmits the command to the control unit 4.

Status Readout Operation of First Embodiment

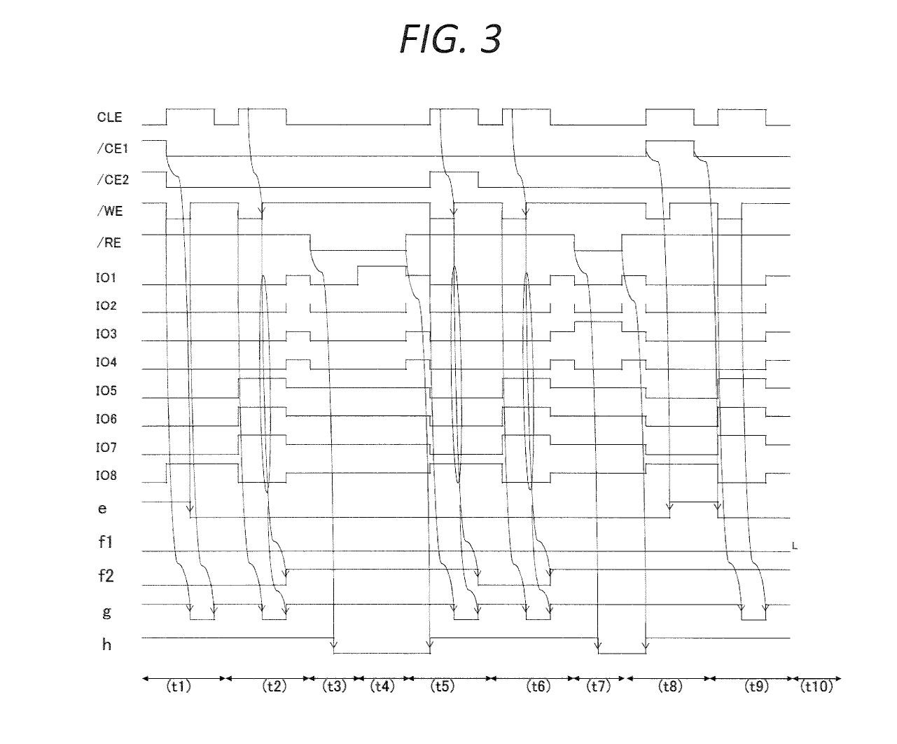

Next, description will be given of the writing operation and the status readout operation of the embodiment using the timing diagram of FIG. 3.

The writing operation of the embodiment is performed together with a status readout. FIG. 3 is a timing diagram of the writing operation command input and the status command input of the first embodiment. As shown in FIG. 3, various types of signal are input to the semiconductor chip. /CE1 and /CE2 are the input signals which are used when selecting the semiconductor chips C1 and C2. When /CE1 and /CE2 are set to L and the signal is transmitted, a state is assumed in which each of the semiconductor chips C1 and C2 are selected. /RE (Read Enable) is an input signal for reading out data from the semiconductor chips C1 and C2. In this case, /RE is selected when it is set to L. /WE (Write Enable) is an input signal line for transmitting a command, an address or data to each of the semiconductor chips C1 and C2. When transmitting, /WE is set to L.

The memory controller 1 of the semiconductor memory device 100 transmits a chip selection signal to each of the semiconductor chips C1 and C2, selects both at once and transmits an operation command (t1). At this time, CLE is set to H, /CE1 and /CE2 are set to L, /WE is set to L, and /RE is set to H. The input-output line 1 to input-output line 7 are set to L, the input-output line 8 is set to H and the command 80h is supplied.

Hereinafter, detailed description will be given of the flow until the operation command is transferred from the input-output line to the first command register. To facilitate the description, description will be given only of a case in which an “H” level or an “L” level signal is supplied to the input-output line 1. Similar operations are performed in relation to the input-output line 2 to the input-output line 8.

The first AND circuit 20 receives an L signal from the chip selection circuit 31 and an L signal from the control signal input circuit 33 and transmits the L signals to the first and second transistors 21 and 22. As a result, the first and second transistors 21 and 22 enter an ON state. In other words, the first and second transistors 21 and 22 each enter a state of being connectable with the power supply voltage (VDD) and ground.

Here, when the first data input control unit 41 receives an “H” level signal from the input-output line 1, the third transistor 23 enters an ON state, and the fourth transistor 24 enters an OFF state. Therefore, the “L” level signals are supplied to the first command register 13 via the first and third transistors 21 and 23.

Meanwhile, when the first data input control unit 41 receives an “L” level signal from the input-output line 1, the third transistor 23 enters an OFF state, and the fourth transistor 24 enters an ON state. Therefore, the “H” level signals (VDD) are supplied to the first command register 13 via the second and fourth transistors 22 and 24. The “L” signal or the “H” signal supplied to the first command register 13 corresponds to data of one of “1” or “0”. Subsequently, the control unit 4 performs a data writing operation on the basis of the command of the first command register 13 (t1).

Subsequently, in order to discover the writing state, the memory controller 1 transmits a chip selection signal and a status command to each of the semiconductor chips C1 and C2 (t2). At this time, CLE is set to H, /CE1 and /CE2 are set to L, /WE is set to L, and /RE is set to H. The status command is transmitted to each of the semiconductor chips C1 and C2 via the bus b. The data input-output circuit 3 receives the status command in the same manner as in (t1), and transmits the signal to the first command register 13.

When the memory controller 1 transmits the status command, the input-output line 1 to the input-output line 8 are set to a high impedance state in anticipation of the output from the semiconductor chip. Subsequently, the semiconductor chips C1 and C2 perform the following operations on the basis of this operation.

The semiconductor chips C1 and C2 transmit the status of each of the semiconductor chips C1 and C2 from the respective data input-output circuits 3 to the memory controller 1 via the bus b, on the basis of the status command (t3). At this time, CLE is set to L, /CE1 and /CE2 are set to L, /WE is set to H, and /RE is set to L.

During the status output of (t3), selection of the bus b is performed by the chip recognition circuit 32 according to the chip distinction number. For example, the semiconductor chip C1 is set to the chip distinction number (1) and the semiconductor chip C2 is set to the chip distinction number (2). For example, when the bus b includes the input-output line 1 to the input-output line 8, in the semiconductor chip of the chip distinction number (1), e.g., the semiconductor chip C1, outputs the status information from the input-output lines 1 and 2, and the input-output line 3 to the input-output line 8 are set to a high impedance state. In the chip distinction number (2), e.g., the semiconductor chip C2, the status information is output from the input-output lines 3 and 4, and the input-output lines 1, 2 and input-output line 5 to input-output line 8 are set to a high impedance state. When the writing operation of the semiconductor chip C1 finishes, from the status of “writing”, the semiconductor chip C1 transmits the status of “writing finished” to the memory controller 1 via the input-output lines 1 and 2. At this time, the semiconductor chip C1 transmits an H signal from the input-output line 1.

Hereinafter, detailed description will be given of the flow until the status data is transferred to the bus d. To facilitate the description, description will be given only of a case in which an “H” level or an “L” level signal is supplied to the input-output line 1. Similar operations are performed in relation to the input-output line 2 to the input-output line 8.

The second AND circuit 25 receives an L signal from the chip selection circuit 31, an L signal from the input-output selection circuit 30 and an L signal from the control signal input circuit 33 and transmits the L signals to the fifth and the sixth transistors 26 and 27. As a result, the fifth and sixth transistors 26 and 27 enter an ON state. In other words, the fifth and the sixth transistors 26 and 27 each enter a state of being connectable with the power supply voltage (VDD) and ground.

Here, when the first data input control unit 41 receives an “H” level signal from the status register 11, the seventh transistor 28 enters an ON state, and the eighth transistor 29 enters an OFF state. Therefore, the “L” level signals are supplied to the bus d via the fifth and the seventh transistors 26 and 28.

Meanwhile, when the first data input control unit 41 receives an “L” level signal from the status register 11, the seventh transistor 28 enters an OFF state, and the eighth transistor 29 enters an ON state. Therefore, the “H” level signals (VDD) are supplied to the bus d via the sixth and the eighth transistors 27 and 29. The “L” signal or the “H” level signal supplied to the bus d corresponds to data of one of “1” or “0”. Subsequently, the signals are transmitted to the memory controller 1 (t3).

When the writing of the semiconductor chip C1 finishes, the semiconductor chip C1 outputs the H signal to the input-output line 1. Since the writing is not finished in the semiconductor chip C2, the semiconductor chip C2 continues to output the status of “writing” as L signals from the bus input-output lines 3 and 4 (t4). At this time, CLE is set to L, /CE1, /CE2 and /WE are set to H, and /RE is set as-is to L. When the semiconductor chips C1 and C2 finish transmitting the status, the input-output line 1 to the input-output line 8 enter a high impedance state (t4). On the basis of this operation, the memory controller 1 performs the following operations in which the memory controller 1 selects the semiconductor chip C1 again on the basis of the status information and transmits a write command (t5). At this time, CLE is set to H, /CE1 is set to L, /CE2 is set to H, /WE is set to L, and /RE is set to H.

Subsequently, using the same method as when transmitting the first status command, the memory controller 1 selects the semiconductor chips C1 and C2 both at once and transmits the status command (t6). At this time, CLE is set to H, /CE1 is set to L, /CE2 is set to L, /WE is set to L, and /RE is set to H. When the memory controller 1 finishes transmitting the command, the input-output line 1 to the input-output line 8 enter a high impedance state. The semiconductor chips C1 and C2 perform the following operations on the basis of this operation.

Each of the selected semiconductor chips C1 and C2 selects the bus b which corresponds to the respective chip distinction number and transmits the status data to the memory controller 1 (t7). At this time, CLE is set to L, /CE1 and /CE2 are set to L, /WE is set to H, and /RE is set to L. The memory controller 1 performs the following operations on the basis of the status data which is transmitted from the semiconductor chip.

The memory controller 1 receives the statuses of each of the semiconductor chips (/RE is L) and sets the /RE of the semiconductor chips to H in order to issue the command. Accordingly, the semiconductor chips set the input-output line 1 to the input-output line 8 to a high impedance state. The memory controller 1 transmits the write command to each of the semiconductor chips C1 and C2 in the order in which the semiconductor chips C1 and C2 are determined to be writable (t8). Since the semiconductor chip C2 is determined to be writable, at this time, CLE is set to H, /CE1 is set to H, /CE2 is set to L, /WE is set to L, and /RE is set to H. Subsequently, the transmission operation of the status command is performed (t9). CLE is set to H, /CE1 and /CE2 are set to L, /WE is set to L, and /RE is set to H. The writing and status readout operations are repeated a predetermined number of times using the same method (t10).

Furthermore, in the embodiment, the semiconductor chips C1 and C2 are used, however, three or more semiconductor chips may also be used. For example, when the semiconductor chips C1, C2, C3 and C4 are included, the input-output lines 1 and 2, the input-output lines 3 and 4, the input-output lines 5 and 6, and the input-output lines 7 and 8 of the bus b are assigned to the semiconductor chips C1, C2, C3 and C4, respectively. The input-output lines 1 to 8 which are not assigned to each of the semiconductor chips are set to a high impedance state. For example, in the case of the semiconductor chip C1, the input-output lines 3 to 8 of the bus b, which is connected to the semiconductor chip C1, are in a high impedance state.

Effects of First Embodiment

As a comparative example, a case is considered in which in the writing operation and the status readout operation, each of the semiconductor chips is selected individually, and the status data of each of the semiconductor chips is read out individually.

In this case, it is necessary that the memory controller 1 supply the readout commands for reading out the status to the semiconductor chips individually. It is necessary to supply the command the same number of times as the number of semiconductor chips which are present.

However, in the embodiment, the memory controller 1 selects the semiconductor chips C1 and C2 at the same time and supplies the readout commands. As a result, the status of a plurality of the semiconductor chips can be read by issuing a status command once. Therefore, the time spent reading out the status from a plurality of the semiconductor chips can be shortened, the number of times the status command is issued can be suppressed, and therefore, the power consumption can be reduced. In addition, since the bus b is used in common between the semiconductor chips, in obtaining the status information by switching between each of the semiconductor chips, the command input data and the status data move back and forth within the bus b, and charge and/or discharge currents are generated in the bus b. Therefore, the power consumption of the semiconductor memory device of the embodiment can be reduced in comparison to a comparative example, the more semiconductor chips are present or the more times the status command is issued.

### Second Embodiment

### Configuration of Second Embodiment

The connection example of the second embodiment is essentially the same as the block diagram of the semiconductor memory device of FIG. 2. However, the second embodiment differs from the first embodiment in that the semiconductor chips C1 and C2 include a second command register 35, are connected to the memory controller 1 via signal lines d1 and d2, and receive a storage unit control signal from the memory controller 1. Hereinafter, description will be given of the semiconductor memory device of the second embodiment.

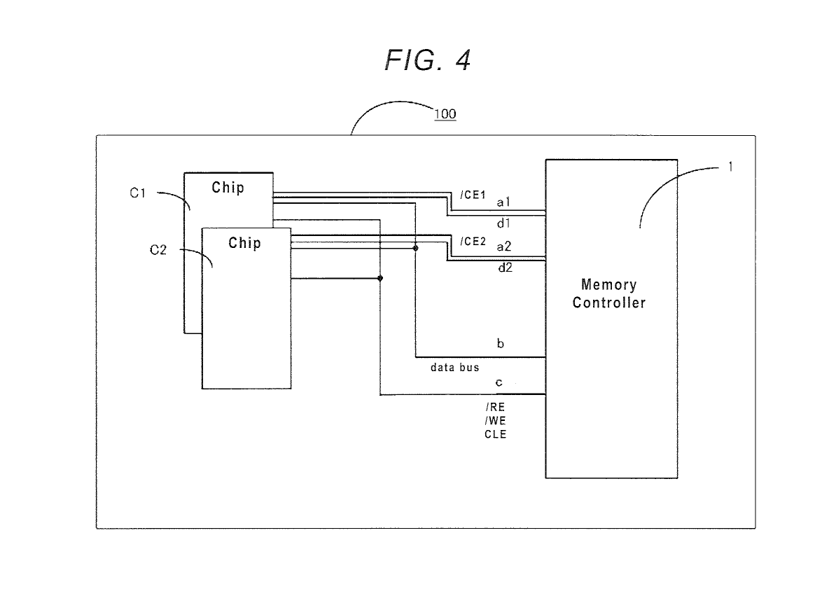

FIG. 4 is a view showing an example of the connections between the semiconductor chips and the memory controller 1 of the semiconductor memory device 100 of the second embodiment. Each of the semiconductor chips C1 and C2 is connected to the memory controller 1 via the signal lines d1 and d2.

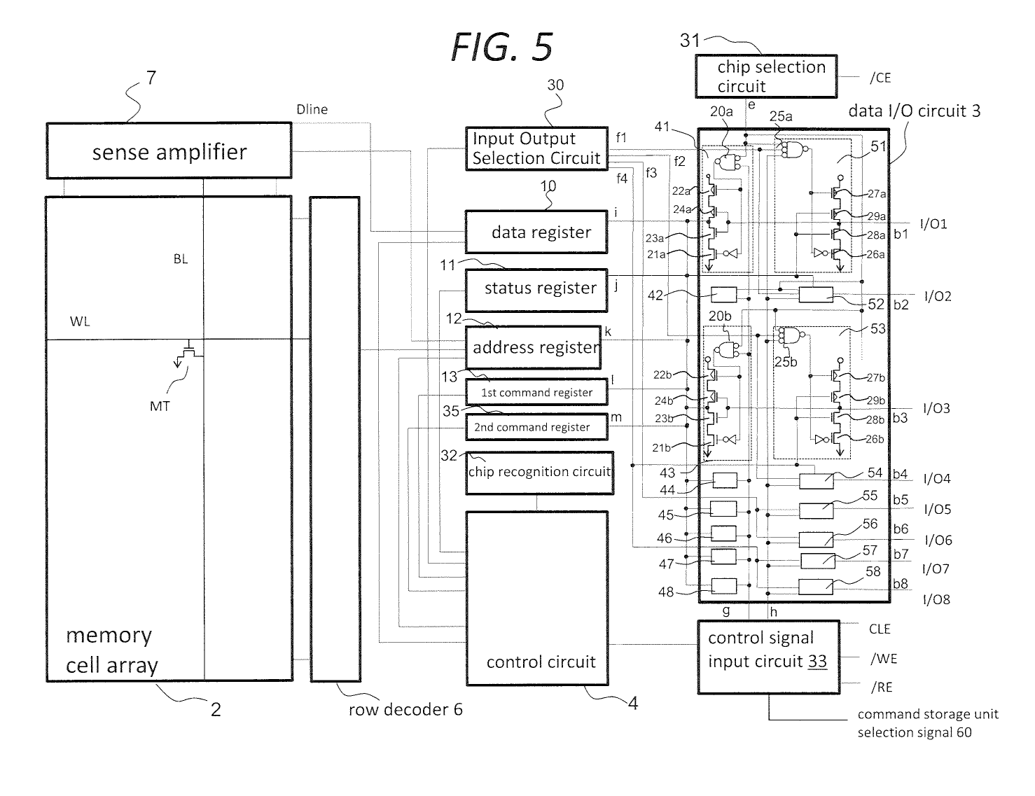

FIG. 5 is a block diagram showing the configuration of the semiconductor chip of the semiconductor memory device 100 of the second embodiment.

As shown in the diagram, the semiconductor memory device 100 includes the second command register 35.

In the second embodiment, the memory controller 1 transmits the command storage unit selection signal to the semiconductor chips C1 and C2 via the signal lines d1 and d2. When the control unit 4 receives the command storage unit selection signal via the control signal input circuit 33, the control unit 4 selects the second command register.

Operation Method of Second Embodiment

Description will be given of the operation method of the semiconductor memory device 100 of the second embodiment using the drawings. Hereinafter, the operation method of the semiconductor memory device 100 of the second embodiment will be shown.

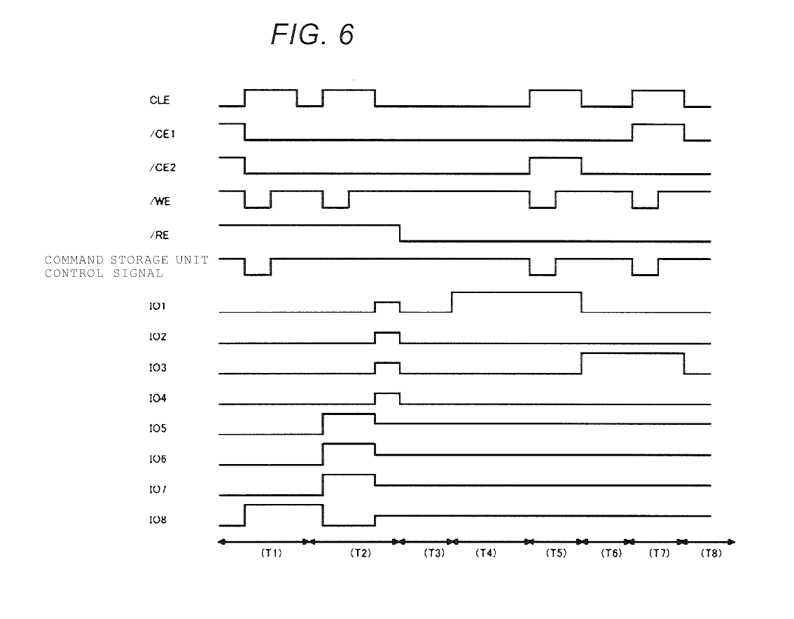

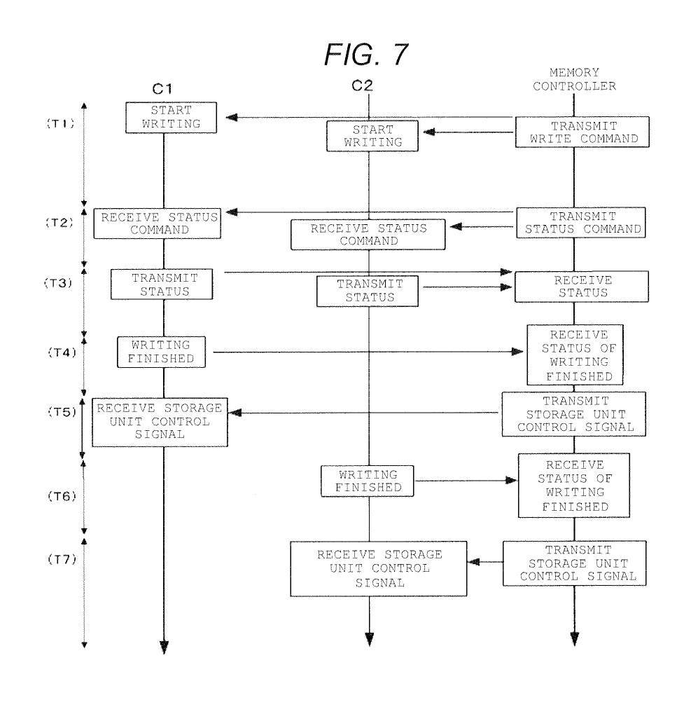

FIG. 6 is a timing diagram of an operation command input and a status command input of the semiconductor memory device 100 of the second embodiment. FIG. 7 is a diagram showing the flow of operations of the semiconductor chip and the memory controller 1 of the semiconductor memory device 100 of the second embodiment.

As shown in FIG. 6, each of the input signals of the memory controller 1 is shown. A command storage unit control signal is provided in the embodiment. When the command storage unit control signal is set to L, the second command register is selected and the command stored in the second command register is issued. The other signals are the same as those in the first embodiment.

First, the memory controller 1 transmits a chip selection signal, a command storage unit selection signal and a write command to each of the semiconductor chips C1 and C2 (T1). As shown in FIG. 7, at this time, CLE is set to H, /CE1 and /CE2 are set to L, /WE is set to L, /RE is set to H, and the command storage unit control signal is set to L. The chip recognition circuits 32 within the semiconductor chips C1 and C2 select the second command register on the basis of the chip selection signal and the command storage unit selection signal. The selected second command register stores the write command which is received from the memory controller 1 (T1). The control unit 4 starts the writing operation on the basis of the write command of the second command register (T1).

Next, the memory controller 1 transmits a status command to the semiconductor chips C1 and C2 at the same time and selects the semiconductor chips C1 and C2 at the same time (T2). At this time, CLE is set to H, /CE1 and /CE2 are set to L, /WE is set to L, /RE is set to H, and the command storage unit control signal is set to H. When the memory controller 1 finishes transmitting the status command, the input-output line 1 to the input-output line 8 enter a high impedance state. The semiconductor chips C1 and C2 perform the following operations on the basis of this operation.

Next, the semiconductor chips C1 and C2 respectively select the bus b according to the chip distinction number and transmit the status of each of the semiconductor chips C1 and C2 to the memory controller 1 (T3). At this time, CLE is set to L, /CE1 and /CE2 are set to L, /WE is set to H, /RE is set to L, and the command storage unit control signal is set to H.

When the writing of the semiconductor chip C1 finishes, the status of the semiconductor chip C1 is transmitted to the memory controller 1 (T4).

The memory controller 1 receives the change of the status of the semiconductor chip C1, selects the semiconductor chip C1 on the basis of the change and executes the command which is stored in the second command register. The semiconductor chip C1 which receives the command storage unit control signal selects the second command register and performs an operation again on the basis of the command which is stored in the second command register (T5). At this time, CLE is set to H, /CE1 is set to L, /CE2 is set to H, /WE is set to L, /RE is set to L, and the command storage unit control signal is set to L.

Similarly, after finishing the writing operation, the semiconductor chip C2 transmits the status of itself to the memory controller 1 (T6). CLE is set to L, /CE1 and /CE2 are set to L, /WE is set to H, /RE is set to L, and the command storage unit control signal is set to H.

Next, the memory controller 1 transmits the command storage unit control signal to the semiconductor chip C2 on the basis of the received status (T7). At this time, CLE is set to H, /CE1 is set to H, /CE2 is set to L, /WE is set to L, /RE is set to L, and the command storage unit control signal is set to L. The semiconductor chip C2 selects the second command register on the basis of the signal and performs the writing operation on the basis of the command which is issued from the second command register.

Effects of Second Embodiment

In the embodiment, the semiconductor chips C1 and C2 store the write command in the second command register within the semiconductor chip at the same time the writing operation is performed.

By selecting the semiconductor chips C1 and C2 using /CE1 and /CE2, the memory controller 1 selects the semiconductor chips C1 and C2 at the same time and transmits the status commands. Furthermore, the status of the semiconductor chips C1 and C2 is continually output from the bus b, which is selected according to the chip distinction number.

When the next writing operation becomes possible according to the status information, the memory controller 1 executes the command using the command which is stored in the second command register in advance and does not execute the command input via the bus b and therefore, it is not necessary to use the bus b. Therefore, the bus b can continually output the status information of each chip.

When the embodiment is compared to the first embodiment, it is possible to suppress the number of times that the commands are transmitted, and furthermore, it is possible to suppress the power consumption.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor memory device comprising:
a first semiconductor chip which includes a first data input-output circuit connected to a plurality of output lines including first and second output lines and configured to output a status signal onto the first output line; and
a second semiconductor chip which includes a second data input-output circuit connected to the plurality of output lines including the first and second output lines and configured to output a status signal onto the second output line.

2. The device according to claim 1, wherein the first data input-output circuit is configured to also output data signals onto the first and second output lines, and the second data input-output circuit is configured to also output data signals onto the first and second output lines.

3. The device according to claim 1, wherein the first input-output circuit outputs the status signal onto the first output line when a status read command and a chip enable signal are received by the first semiconductor chip, and the second input-output circuit outputs the status signal onto the second output line when a status read command and a chip enable signal are received by the second semiconductor chip.

4. The device according to claim 1, wherein the status read commands and the chip enable signals are received by the first and second semiconductor chips at substantially the same time.

5. The device according to claim 4, wherein the status signals are output onto the first and second output lines at substantially the same time.

6. The device according to claim 1, wherein each of the first and second semiconductor chips includes a memory cell array.

7. The device according to claim 1, wherein each of the first and second semiconductor chips includes a chip recognition circuit by which one or more of the output lines onto which the status signal is output are selected.

8. The device according to claim 7, wherein each of the first and second semiconductor chips includes a chip selection circuit configured to receive a chip enable signal.

9. The device according to claim 8, wherein each of the first and second semiconductor chips includes a first command register for storing a status read command and a second command register for storing a write command.

10. The device according to claim 9, wherein each of the first and second semiconductor chips continually outputs the status signal to the selected output lines while a write operation according to the write command stored in the second command register is performed therein in response to a control signal received over a control line different from the output lines.

11. A semiconductor memory device comprising:
a plurality of semiconductor chips each including a data input-output circuit connected to a plurality of output lines, a first command register for storing a status read command, a second command register for storing a write command, and a chip recognition circuit according to which one or more output lines onto which a status signal is output are selected,
wherein different output lines are selected for each of the semiconductor chips.

12. The device according to claim 11, wherein the status signals of different semiconductor chips are output onto the output lines at the same time.

13. The device according to claim 12, wherein the data input-output circuit of each semiconductor chip is configured to cause non-selected output lines to go into a high impedance state.

14. The device according to claim 11, wherein each of the semiconductor chips includes a chip selection circuit configured to receive a chip enable signal and a control unit configured to receive a control signal for causing the write command stored in the second command register to be issued.

15. The device according to claim 11, wherein each of the semiconductor chips continually outputs to the selected output lines while a write operation according to the write command stored in the second command register is performed therein in response to the control signal.

16. The device according to claim 15, wherein the semiconductor chips include first and second semiconductor chips and the control signal is received by the first semiconductor chip over a first control line and the control signal is received by the second semiconductor chip over a second control line that is different from the first control line, and the first and second control lines are different from the output lines.

17. A semiconductor memory device comprising:
a plurality of semiconductor chips each including a chip selection circuit configured to receive a chip enable signal, a chip recognition circuit, and a data input-output circuit connected to a plurality of output lines that are controlled based on control signals from the chip selection circuit and the chip recognition circuit,
wherein the control signal from the chip selection circuit causes all of the output lines to go into a high impedance state when a chip enable signal is not received by the chip selection circuit and the control signal from the chip recognition circuit causes some of the output lines go into the high impedance state when the chip enable signal is received by the chip selection circuit.

18. The device according to claim 17, wherein each of the semiconductor chips includes a first command register for storing a status read command and a second command register for storing a write command.

19. The device according to claim 17, wherein the output lines of a semiconductor chip that go into the high impedance state when the chip enable signal is received by the chip selection circuit of the semiconductor chip are different for different semiconductor chips.

20. The device according to claim 17, wherein each of the first and second semiconductor chips includes a memory cell array.
